(19) United States
(12) Patent Application Publication
(10) Pub. No.: US 2010/0247712 A1
(43) Pub. Date: Sep. 30, 2010

(54) FOOD COMPOSITIONS COMPROMISING DRIED PROBIOTICS, METHODS OF MANUFACTURE AND USES THEREOF

(76) Inventor: Marvin J. Rudolph, Sharon, MA (US)

Correspondence Address: CESARI AND MCKENNA, LLP, 88 BLACK FALCON AVENUE, BOSTON, MA, 02210, US

(21) Appl. No.: 12/732,314

(22) Filed: Mar. 26, 2010

Related U.S. Application Data
(60) Provisional application No. 61/163,773, filed on Mar. 26, 2009.

(51) Int. Cl. A23L 1/28

(52) U.S. Cl. 426/61

(57) ABSTRACT

The present invention is directed to a food composition including an edible base mix component and a dried probiotic component which that may be stored at room temperature and converted to a frozen dessert with minimal effects to the viability of probiotics. Accordingly, a consumer ingesting the frozen dessert is provided with a beneficial amount of viable probiotics. Also provided herein are one or more methods for manufacturing the food compositions and using the subject food composition in frozen dessert products.

### CROSS-REFERENCE TO RELATED APPLICATIONS

The present application claims the benefit of U.S. Provisional Patent Application Ser. No. 61/163,773, which was filed on Mar. 26, 2010, by Marvin J. Rudolph for a FOOD COMPOSITIONS COMPROMISING DRIED PROBIOTICS, METHODS OF MANUFACTURE AND USES THEREOF and is hereby incorporated by reference.

### BACKGROUND OF THE INVENTION

1. Field of the Invention

The invention relates generally a system and method for manufacturing and providing food compositions that include dried probiotics that may be stored at room temperature and manufactured at freezing temperatures with minimal effects to the viability of probiotics and the flavoring of a frozen dessert product.

2. Background Information

The human intestinal tract is home to a host of bacteria. However, not all of these bacteria are pathogenic. Some bacteria, called normal flora, are beneficial to us. For instance, various bacteria that inhabit the intestinal track produce a mildly acidic environment which curbs the growth of pathogenic bacteria. Other benefits incurred from bacteria within our intestinal tract include stronger immune systems, normalized bowel movements, controlled cholesterol levels, the prevention of yeast and fungal infections and an increase in the bioavailability of vitamins, fatty acids, lactase, and calcium to name a few. Some bacteria even provide anti-carcinogenic activities by modifying the production of carcinogens produced by certain flora within the intestinal tract.

However, when there is a decrease in the number of beneficial bacteria, the intestinal tract is thrown off balance, thereby resulting in an overgrowth of pathogenic bacteria, yeasts, and viruses. This imbalance may cause stress to the immune system and eventually lead to disease. There are many ways in which the beneficial bacterial population may become imbalanced within our intestinal tract. Often, chlorinated drinking water not only kills harmful bacteria, but also destroys the beneficial bacteria within our system. Moreover, the use of antibiotics, radiation, chemotherapy, chemical treatment of our food sources, e.g., livestock and plants, and even alcohol abuse are all significant factors that result in an imbalanced population of pathogenic and beneficial bacteria within our intestinal tract.

In order to maintain a healthy intestinal tract, many people take supplements that include beneficial bacteria. For example, there are many foods that now include beneficial bacteria. These beneficial bacteria are referred to as “probiotics” and are defined as “a live microbial food supplement that affects the host animal beneficially by improving its intestinal microbial balance” (Fuller, R. Probiotics in Man and Animals; J. Appl. Bacteriol. 1989. 66: 365-378). This approach enables a person to supplement the probiotics in their digestive tract by the foods they eat. Food products containing probiotics may be provided in yogurts, smoothies, snack bars, cereals, baby formula and chocolate, only to name a few.

However, the influence of storage conditions on probiotic viability is a major problem with the production of probiotic food products. When a probiotic food product is stored at room temperature, the probiotics therein are capable of propagating under ideal growth conditions. This may lead to an increase in the probiotic population in the food product. As the probiotic population increases, the food product may become more acidic and the available nutrients therein may start to diminish, which in turn, may result in a significant decrease in probiotic viability. One way to avoid this problem is to store probiotic food products under chilled/freezing conditions to slow down bacterial cell growth and maintain probiotic viability. Storing probiotic food products in this manner can be quite costly. Refrigerated storage equipment is expensive and requires a high expenditure of energy. Therefore, typically, there is an increased cost ultimately passed on to the consumer of the probiotic food product.

Because temperature is significant in probiotic viability, refrigerated and frozen food compositions, such as yogurt, have been suggested in the past for use in providing probiotics to the digestive tract.

However, it is difficult to incorporate probiotics into frozen foods because the introduction of air during the freezing process causes a loss in viable probiotic bacteria because the fluctuating temperature causes the formation of ice crystals which may rupture the bacterial cell walls, thereby reducing viability.

Accordingly, it would be advantageous to provide a food product composition that is capable of being stored at room-temperature conditions, while still being able to include viable probiotics without the uncontrolled propagation of the bacteria and/or concomitant build up of acid that both reduces the viability of the included probiotics and adversely affects the taste of the food product. There also continues to be a need, for food product compositions that are capable of allowing for the delivery of viable probiotics to a subject to provide health benefits to a consumer thereof, as well as a need is for the development of methods for optimizing probiotic food composition storage conditions.

### SUMMARY OF THE INVENTION

The invention is directed to improvements of food compositions containing an edible base mix component and a dried probiotic component. Such improvements allowing dried probiotics to be stored at room temperature and manufactured at freezing temperatures with minimal effects to the probiotics during the freezing process. In particular, the edible base mix component may include any suitable food component, such as one or more dairy components (e.g., milk or cream components), a sweetener component (e.g., sugar, dextrose, fructose, corn syrup, maple sugar, honey, brown sugar, malt syrup, molasses, lactose), an egg component (e.g., liquid eggs, frozen eggs, dried eggs, egg yolks, frozen egg yolks, dried egg yolks), water, a stabilizer (e.g., sodium alginate, gelatin, gum acacia, guar seed gum, gum karaya, locust bean gum, gum tragacanth, carrageenan, furcellaran, sodium carboxymethylcellulose, psyllium seed husk), an emulsifier (e.g., lecithin, mono and/or diglycerides, polyoxyethylene (20) sorbitan tristearate, polysorbate 80), a thickener (e.g., propylene glycol alginate, microcrystalline cellulose, sodium citrate, disodium phosphate, tetrasodium pyrophosphate, sodium hexametaphosphate, calcium oxide, magnesium oxide, calcium hydroxide, magnesium hydroxide), and/or the like.

In the illustrative embodiment of the present invention, the edible base mix is a dessert mix, such as a dessert mix employed in the production of a frozen dessert. The base mix may be in liquid or dry powder form.

The probiotic component may include a probiotic bacterial strain, such as any suitable viable probiotic bacterial strain that is capable of being dried and/or frozen while maintaining its viability. For instance, a suitable bacterial strain may be a strain of the genera Lactobacillus, Bifidobacterium, and/or Streptococcus. In some instances, the probiotic bacterium may be Lactobacillus acidophilus, Lactobacillus bulgaricus, Bifidobacterium bifidum, and/or Streptococcus thermophilus. In certain instances, the probiotic component may be freeze-dried or spray dried.

In the illustrative embodiment of the present invention, the edible base mix component is combined with the dried probiotic component to produce a food composition for use in the production of a food product. A novel feature of the subject food compositions containing a dried probiotic component is that the compositions are capable of being transported and/or stored at room temperature and then processed and converted to a frozen food product having/including a viable probiotic component with minimal effects to the probiotics contained therein. The edible base mix component and the probiotic component of the food composition may be combined before or after transport and at any suitable time prior to formation of the illustrative frozen food product. In certain instances, the food product is a dessert product which may be frozen in a particular manner to produce a frozen yogurt or ice cream.

Accordingly, in certain instances, the edible base mix component and the probiotic component are capable of being transported, stored, and combined at one temperature, e.g., room temperature, and further capable of being processed, e.g., mixed, and/or served at a second temperature, e.g., a temperature below room temperature. That is, the second temperature may be substantially below room temperature, however, at the same time is able to maintain the viability of the probiotic component.

In certain instances, the food products provided herein are capable of providing a beneficial amount of viable probiotics to a subject consuming the food product, e.g., frozen dessert. Also provided are methods for manufacturing the food compositions, methods for using the same for the production of a food product, and methods for the use of the subject food composition, such as in frozen desserts, for the prevention and treatment of an adverse condition.

### BRIEF DESCRIPTION OF THE DRAWINGS

The invention description below refers to the accompanying drawings, of which:

FIG. 1 is an illustrative embodiment of the present invention illustrating a diagrammatic view of the manufacturing and distribution system and method for producing, shipping and converting the subject food compositions; and

FIG. 2 is an illustrative embodiment of the present invention illustrating an isometric view, with parts broken away, showing an exemplary apparatus for producing and dispensing an aerated frozen food product utilizing the novel aspects of this invention.

### DETAILED DESCRIPTION OF AN ILLUSTRATIVE EMBODIMENT

Throughout this application, various publications, patents, and published patent applications are cited. The disclosures of these publications, patents, and published patent applications referenced in this application are hereby incorporated by reference in their entirety into the present disclosure. Citation herein by the Applicant of a publication, patent, or published patent application is not an admission by the Applicant of said publication, patent, or published patent application as prior art.

The illustrative embodiment of the present invention provides food compositions that include dried probiotics as well as an apparatus and method for manufacturing the same and for uses thereof. The food compositions may include an edible base mix component and a dried probiotic component, such as a freeze-dried probiotic or spray dried probiotic component. A novel feature of the edible base mix component, dried probiotic component, and/or the food compositions disclosed herein (hereinafter “the food product”) is that the food product allows for transport and/or storage of the food product at room temperature, while at the same time allowing the food product to be converted from a non-frozen to a frozen form, and when converted to a frozen form, providing a beneficial amount of a viable probiotic to a subject consuming the frozen food product. Also provided are methods of manufacturing the food products and use thereof of for the prevention and/or treatment of an adverse condition.

### Base Mix Component

As summarized above, the subject food compositions may include an edible base mix component and a probiotic component. Any suitable base mix component may be included so long as the base mix component is edible and safe to consume. In certain instances, the base mix component includes one or more individual components that may be mixed together to provide an edible composition having nutritional value. Accordingly, the base mix component may be a food component such as a diary component (e.g., a milk or cream), a sugar and/or corn syrup component, an egg component, a stabilizer, thickener, water, and/or the like.

The edible base mix component may include a dairy source, such as whole milk, skim milk, condensed milk, evaporated milk, anhydrous milk fat, cream, butter, butterfat, whey, and/or milk solids non-fat (MSNF). The dairy source, may contribute dairy fat and/or non-fat milk solids such as lactose and milk proteins (e.g., whey proteins), and caseins to the overall edible composition. The diary source may also include a vegetable fat, for example, cocoa butter, palm, palm kernel, soybean, cottonseed, coconut, grapeseed, canola, sunflower oils, and mixtures thereof. MSNF may also be included in the edible base mix component. Typically, MSNF is made up of approximately 38% milk protein, 54% lactose, and 8% minerals and vitamins.

In certain instances, the edible base mix may further include a sugar source such as sucrose, glucose, fructose, lactose, dextrose, invert sugar (in either crystalline or liquid syrup form), or mixtures thereof. Additionally the sweetener may also be a corn sweetener in either a crystalline form of refined corn sugar (dextrose and fructose), a dried corn syrup (corn syrup solids), a liquid corn syrup, a maltodextrin, glucose, or a mixture thereof. Sugar substitutes, sometimes called high performance sweeteners, such as sucralose, saccharin, sodium cyclamate, aspartame, and acesulfame may be used in addition to or in place of some or all of the sugar as an additional or alternate sugar source.

Other ingredients that may be added to the edible base mix component include an egg component, (e.g., liquid eggs, frozen eggs, dried eggs, egg yolks, frozen egg yolks, dried egg yolks, and/or egg whites), fruits (e.g., strawberries, blueberries, raspberries, blackberries, bananas, oranges, tangerines, melons, and the like), flavorings, and colorings. Thickeners and/or emulsifiers may also be included in the edible base mix. Emulsifiers may illustratively include, propylene glycol monostearate, sorbitan tristearate, polyoxyethylene (20) sorbitan tristearate, polysorbate 80, lactylated mono glycerides and diglycerides, acetylated monoglycerides and diglycerides, unsaturated monoglycerides and diglycerides, (e.g., mono glycerides and diglycerides of oleic acid, linoleic acid, linolenic acid, or other commonly available higher unsaturated fatty acids), and mixtures thereof. These emulsifiers may make up about 0.01%-3% of the mix.

The illustrative edible base mix may also include a stabilizer to help maintain the acceptable organoleptic properties of the edible base mix. Additionally, stabilizers may also be added to maintain homogeneity and to control ice-crystal growth during a freezing and/or aeration step such as during a manufacturing process of a food product, such as a frozen dessert. In addition, various stabilizers may be included because of their ability to resist structural changes during heat shock, and/or temperature cycling that may occur during transport, storage, and production of the food product. Further stabilizers or other components may be included to prevent ice-crystal formation from occurring. Ice-crystal formation may lead to the deterioration of the overall composition due to structural changes resulting from the formation of the ice-crystals. Stabilizers may also be included in a frozen food product to provide for a uniform meltdown, mouth feel, and texture of a typical frozen dessert. In certain instances, the stabilizer may contain microcrystalline cellulose that has been co-processed with other hydrocolloid gums, such as, for example, alginate, guar gum, and/or xanthan gum, any of which may be useful in the practice of the invention. Additional stabilizers may include, but are not limited to, gelatin, gum acacia, gum karaya, locust bean gum, gum tragacanth, carrageenan, furcellaran, sodium carboxymethylcellulose, and psyllium seed husk.

In addition to the ingredient provided above the edible base mix component may also include water which may be used, e.g., for dilution and/or liquefaction purposes.

In certain aspects of the illustrative embodiment of the present invention, the edible base mix composition is a dessert mix. Accordingly, in some embodiments, the edible base mix may also include several ingredients that may be employed to make a dessert mix. For instance, in some embodiments, the dessert mix may include at least one or more of the following ingredients: concentrated milk fat, butter, butter oil, sweet cream buttermilk, condensed sweet cream buttermilk, dried sweet cream buttermilk, concentrated cheese whey, dried cheese whey, FD&C colors, and additional flavorings.

Where the dessert mix includes a plurality of components, the components can be pre-processed or non-processed. That is, in some of the illustrative embodiments, various components of the dessert mix may be pre-processed to be dehydrated and/or otherwise processed to be included in the final mix composition in a dried and/or powder form. In other embodiments, various components of the dessert mix may be substantially non-processed, and may therefore be present in the final mix composition in its natural solid or fluid form. To the extent that a mix component is pre-processed, it may be processed in any suitable manner. Accordingly, the edible base mix composition may be in any suitable form (e.g., a solid, a liquid, a dispersion, etc.).

For example, in one particular embodiment, the base mix may include the following:
30% milk,
15% cream,
0.5% sugar, 0.5% corn syrup, etc. . . .

In another particular embodiment, the base mix may include the following
28% milk
19% cream
7% sugar
0.5% corn syrup, etc. . . .

For edible base mix compositions, the percent of an ingredient given is the percent by weight of the indicated ingredient based on the total weight of the mix. Except where indicated by context, terms such as stabilizer, emulsifier, flavoring, and similar terms also refer to alternate mixtures of such materials.

The above components, e.g., ingredients, may be mixed together to produce the is edible base mix component of the subject edible compositions. Any method of mixing known to one of skill in the art may be employed to mix the illustrative compositions. Once all of the ingredients have been mixed together, the edible base mix may then be packaged and sterilized. In some cases, the edible base mix itself may be processed by placing the mix in a pouch that is then sterilized. The edible base mix within the pouch may be sterilized by any suitable manner. For instance, said sterilization may be performed by filling the pouch with heat and steam until the pouch has been completely sealed. This step may occur at an elevated temperature which can range from 150° F. to 400° F., including the range of 175° F. to 350° F., and in other instances may range from 275° F. to 302° F. In other illustrative embodiments, the elevated temperature may specifically be 182° F.

In an exemplary method of mixing a typical 10 gallon batch, whole milk, cream, sugar, high fructose corn syrup, maltodextrin, carrageenan, and stabilizer consisting of guar and locust bean gum are mixed together. First, the liquid ingredients are poured into a 50-gallon capacity high shear mixer with an impeller in the bottom of the tank. The powdered components are added to the mixer with the impeller on or at a moderate speed in order to prevent excessive foaming. These ingredients are mixed for about 15 minutes, or until the solids are well dispersed in the liquid with no visible lumps. The liquid is then transferred to the aseptic processing unit, which consists of a pre-heater, a steam infusion chamber, a vacuum chamber, a homogenizer, and cooling tubes. Next, the liquid is heated to approximately 285° F. for 1-2 seconds in the steam infusion chamber. The liquid is then conveyed to the vacuum chamber to evaporate excess water added by the steam, and homogenized at 1200 psi (at the first stage) and 600 psi (at the second stage) and then cooled to approximately 70° F. The liquid is then collected in a 10-gallon steel milk can. The liquid is collected in a can and then poured into about three 2½ gallon Scholle bags with the sterile mix. The leftover liquid remains in the processing unit for the next time the liquid is processed. At this point, the bags must be kept refrigerated. When the mix is produced for full-scale production, the aseptically processed mix is filled aseptically to the 2½ gallon Scholle bags, and the bags do not have to be refrigerated, since the bag and its contents are sterile.

Once sterilized, the edible mix is essentially free from foreign contaminants. Foreign contaminants are particles or microorganisms that decrease probiotic viability by either directly killing the probiotic component or competing with the probiotic component for nutrients. Foreign contaminants may also cause the consumer to be ill. By the term “essentially” is meant that the pouch is at least 90% free of foreign contaminants. In certain embodiments, the pouch is at least 95% free of foreign contaminants and in other embodiments, the pouch is at least 100% free of foreign contaminants. Exemplary foreign contaminants include, but are not limited to, molds and/or yeasts.

### Probiotic Component

As stated above, illustrative embodiment of the present invention may further include a probiotic component. The probiotic component may be present in its natural form or its processed form. By “natural” form is meant that the viable probiotic is present in the same manner as the probiotic would be in nature. Additionally, processed probiotic may be presented in dried form. Any form of a drying process may be employed so long as it results in the production of a dried probiotic composition, wherein the probiotic component is still viable. That is, the probiotics in the composition must remain viable, even though it is dried and inactive at the time.

In certain aspects, the probiotic component may include bacteria, such as a bacteria belonging to the Lactobacillus genera or Bifidobacterium genera. Exemplary Lactobacillus include, but are not limited to, the following: Lactobacillus acidophilus, Lactobacillus amylovorus, Lactobacillus bulgaricus, Lactobacillus casei, Lactobacillus delbrueckii, Lactobacillus fermentum, Lactobacillus gas seri, Lactobacillus helveticus, Lactobacillus Johnsonii, Lactobacillus lactis, Lactobacillus paracasei, Lactobacillus pentosaceus, Lactobacillus plantarum, Lactobacillus reuteri, Lactobacillus rhamnosus, and Lactobacillus salivarius.

Exemplary Bifidobacterium include, but are not limited to, the following: Bifidobacterium adolescentis, Bifidobacterium animalis, Bifidobacterium bifidum, Bifidobacterium breve, Bifidobacterium infantis, Bifidobacterium lactis, Bifidobacterium longum.

Probiotics within the scope of the illustrative embodiment of the present invention may further include microbial species from the following genera: Escherichia (E. Coli), Clostridium, Lactococcus, Streptococcus, Enterococcus, and Saccharomyces.

In certain embodiments, the probiotics are freeze-dried and/or spray dried and thus the illustrative composition may include a freeze-dried and/or spray dried component including probiotics. The subject freeze-dried or spray dried component may also contain probiotics that include a bacteria that having at least one Lactobacillus species. In another embodiment, the freeze-dried or spray dried component may include at least one Bifidobacterium species.

### Methods of Freeze Drying or Spray Drying the Probiotics

As noted above, aspects of the illustrative embodiment of the present invention include food compositions which contain a dried probiotics that may be freeze-dried. Freeze-drying (also known as lyophilization or cryodesiccation) is a dehydration process in which water is removed from the probiotic component. During this process, the probiotic component is first frozen. Then the surrounding pressure is reduced and enough heat is added to allow the frozen water in the material to sublime directly from a solid phase to a gas phase.

### Freeze Drying

In an exemplary freeze-drying procedure, there are three stages in the process: freezing, primary drying, and secondary drying of the probiotic component.

Freezing

The freezing process may be performed by placing the probiotic material in a freeze-drying flask and rotating the flask in a bath, such as a shell freezer, which is cooled, by mechanical refrigeration, dry ice and/or methanol or liquid nitrogen. On a larger-scale, freezing may be done using a freeze-drying machine. During the freezing process, the probiotic material may be cooled below its eutectic point, which is the lowest temperature at which the solid and liquid phase of the material can coexist. This ensures that sublimation rather than melting will occur in the steps to follow. In order to produce larger crystals, which are easier to freeze dry, the probiotic product may be frozen slowly or may be cycled up and down in temperature.

Primary Drying

In general, during the primary drying phase, the pressure may be lowered and enough heat supplied to the probiotic component for water within the probiotic component to sublimate. In this initial drying phase, about 95% of the water in the material may be sublimated. This phase may be done slowly to ensure that too much heat is not added too quickly, thus resulting in the structure of the probiotic component possibly being altered.

The pressure may be controlled through the application of a partial vacuum. The partial vacuum may be employed to speed sublimation making it useful as a deliberate drying process. Furthermore, a cold condenser chamber and/or a condenser plate may be used to provide a surface upon which water vapor may re-solidify. By utilizing a condenser, water vapor is prevented from reaching the vacuum pump, which could degrade the pump's performance. Illustratively, condenser temperatures should be below −50° C. (−60° F.). It is to be noted that in this pressure phase, heat is mainly transferred by conduction or radiation. That is, although some convectional heat transfer does occur, heat transferred through convectional means is often insignificant in the pressure phase. Thus, conduction or radiation transfer most all of the heat to the probiotic.

Secondary Drying

Since frozen water molecules are typically removed in the primary drying phase, the secondary drying phase may be engaged to remove unfrozen water molecules. This part of the freeze-drying process is governed by the probiotic component's adsorption isotherms. In this phase, the temperature may be raised higher than in the primary drying phase, and can even be above 0° C. to break any physico-chemical interactions that have formed between water molecules and the frozen probiotic component. The pressure may also be lowered in this stage to encourage desorption.

After the freeze drying process is complete, the vacuum may be broken with an inert gas, such as nitrogen, before the material is sealed. At the end of the freeze drying process, the final residual water content in the product may be around 1%-4% or lower.

In certain instances, the probiotics may be suspended in a suitable protective medium during the freeze drying process known as lyoprotectants. These molecules are typically polyhydroxy compounds such as sugars (e.g., monosaccharides, disaccharides, and polysaccharides), polyalcohols, and their derivatives. In particular, trehalose and sucrose are natural lyoprotectants. Trehalose is produced by a variety of plant, fungi, and invertebrate animals that remain in a state of suspended animation during periods of drought (also known as anhydrobiosis).

### Spray Drying

In certain embodiments, the probiotic components may alternatively be spray dried. Spray drying involves the drying of a liquid feed, e.g., containing a probiotic component, using a hot gas. In an exemplary spray drying procedure, this hot gas may be air but in other embodiments of the present invention, an oxygen-free nitrogen gas may be used instead. Spray drying may be a one step rapid process that eliminates a need for additional processing. The liquid feed containing the probiotic may be pumped through an atomizer device that produces fine droplets which are introduced into a main drying chamber. Atomizers vary with rotary, single fluid, two-fluid, and ultra-sonic designs. In some instances, a spray nozzle is used in place of an atomizer for a different dispersion rate.

The hot drying gas can be passed as a co-current flow or counter-current flow to the atomizer direction. The co-current flow enables the particles to have a lower residence time within the system and a particle separator (typically a cyclone device) thereby operating more efficiently. The counter-current flow method enables a greater residence time of the particles in the main drying chamber and may be paired with a fluidized bed system. Spray drying often is used as an encapsulation technique so that the probiotic component and an amphipathic carrier (usually some sort of modified starch) are homogenized as a suspension in water (the slurry). The slurry is then fed into a spray drier, e.g., a tower heated to temperatures well over the boiling point of water, i.e., 100° C. (212° F.).

As the slurry enters the tower, the slurry is atomized. Partly because of the high surface tension of water and partly because of the hydrophobic/hydrophilic interactions between the amphipathic carrier, the water, and the load containing the probiotic component, the atomized slurry forms micelles (drops). Because of the small size of the drops (often averaging 100 micrometers in diameter), a relatively large surface area maybe dried relatively quickly. As the water dries, the amphipathic carrier forms a hardened shell around the load containing the probiotic component.

Load loss (i.e., the amount of probiotic components lost from the process), is usually a function of molecular weight. That is, lighter molecules tend to boil off in larger quantities at the processing temperatures than heavier molecules. Load loss can be minimized industrially by spraying into taller towers. A larger volume of air has a lower average humidity as the process proceeds. By the osmosis principle, water will be encouraged by its difference in fugacities in the vapor and liquid phases to leave the drops and enter the air. Therefore, the same percentage of water can be dried out of the probiotic components, at lower temperatures if larger towers are used. Alternatively, the slurry containing the probiotic component can be sprayed into a partial vacuum. Since the boiling point of a solvent is the temperature at which the vapor pressure of the solvent is equal to the ambient pressure, reducing pressure in the tower has the effect of lowering the boiling point of the solvent. Accordingly, thermal degradation of products can be is overcome by using lower operating temperatures and larger chamber sizes for increased residence times.

Other exemplary protocols that may be employed for drying a probiotic are provided in U.S. Pat. Nos. 7,422,737; 7,229,818; 6,322,994; 6,203,797; 6,200,609; 6,060,050; 3,897,307; 2,127,524 and WO 2001/032835, the disclosures of which are hereby incorporated by reference.

Freeze-dried bacteria may also be purchased commercially. For example, the freeze-dried bacteria may be purchased from The Chris Hansen Labs, which sell freeze dried yogurt bacteria.

### Benefits Provided by the Probiotics

Probiotics are microorganisms which, when administered in adequate amounts, confer a health benefit on the host. For example, Bifidobacteria and lactobacilli are probiotics that are beneficial in treating conditions such as diarrhea, food allergies, dental caries, and respiratory infections to name a few.

The combination of the edible base mix component and the dried probiotic component produces a digestive supplement in the form of a frozen dessert that helps to improve the health of the consumer. Exemplary health benefits are provided in more detail below. Lactobacillus acidophilus may be important in maintaining a healthy, balanced normal flora in the small intestine. This bacterium enhances digestion of milk sugar (lactose) and aids in the production of vitamins and enzymes. In addition, probiotic bacteria may produce lactic acid that suppresses harmful microbes in the intestine and helps to control yeast overgrowth, such as candida.

Lactobacillus casei is a highly prolific and hardy bacteria that is considered the most potent of all Lactobacillus strains. This bacteria is known to produce lactic acid and is capable of digesting a wide range of carbohydrates. It is also likely to shorten the course of acute diarrhea in infants and small children.

Lactobacillus plantarum has a high digestive capacity, particularly for the breakdown of proteins. Because of its ability to eliminate protein wastes from the is intestine before they enter the bloodstream, this bacteria may provide benefits to the immune system. In addition, Lactobacillus plantarum may be able to adhere strongly to the intestinal lining, thereby producing lactic acid and acting as a natural antibiotic (in the form of acidophilin).

Lactobacillus salivarius may be effective in eliminating symptoms of bowel toxemia. These bacteria may produce vitamins Band K, enzymes, and lactic acid, and aids in the production of lactase. Further, Lactobacillus salivarius is very active on proteins as well as the by-products of protein putrefaction and has been proven effective in cases of food poisoning.

Lactobacillus bulgaricus is used in yogurt start-up cultures. These bacteria may produce lactic acid, enhance digestion of milk sugar, and contain natural antibiotic properties.

Streptococcus thermophilus is also used in yogurt start-up cultures. These bacteria may produce lactic acid and lactase.

The Bifidobacterium species aid in digestion and are associated with lower incidences of allergies. These bacteria are also known to prevent some forms of tumor growth and are responsible for the resistance of breast-fed infants to enteric infections.

In certain embodiments, when converted to a frozen dessert, the subject compositions are capable of providing a beneficial amount of viable probiotics to a person consuming the frozen dessert. The illustrative embodiment of the present invention provides one or more of the following benefits: keeping harmful pathogenic species in check by attaching themselves to the intestinal wall and producing a mildly acidic environment which curbs the growth of the harmful, disease-causing microorganism; producing many important enzymes; increasing the bioavailability of vitamins, fatty acids, lactase, and calcium; providing anti carcinogenic activities; strengthening the immune system; neutralizing toxins; normalizing bowel movements; controlling cholesterol levels; countering allergies and skin problems; increasing energy; improving digestion; reducing constipation and diarrhea; reducing foul breath and body is odor; minimizing cold and flu symptoms; reducing blood pressure; weight loss; and preventing of yeast and fungal infections.

### Methods of Manufacturing the Compositions by Combining the Two Components

As summarized above, the subject food compositions may include a composition in which an edible base mix component is combined with a probiotic component. In certain instances, the food compositions include a dried probiotic component.

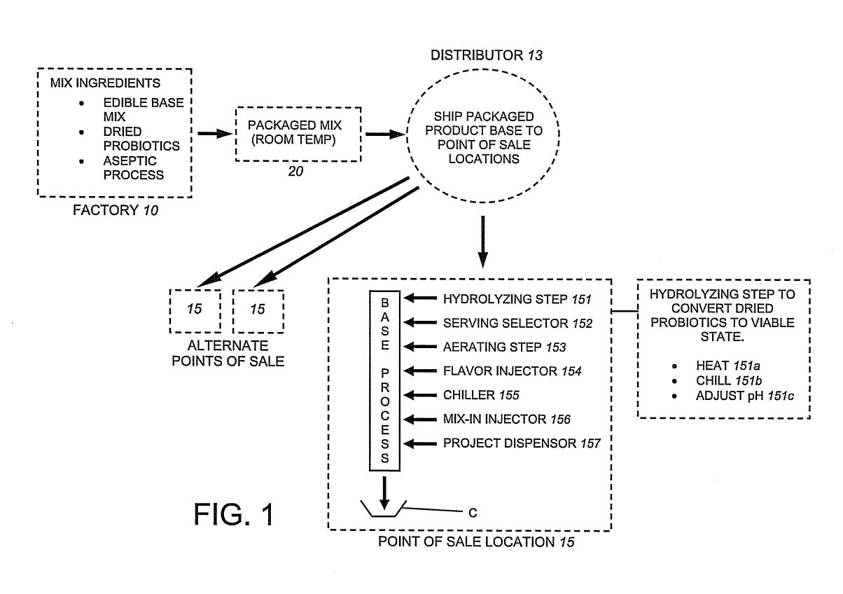

Illustratively, the edible base mix may be manufactured at a factory in which the ingredients are combined together. As shown in FIG. 1, the edible base mix is manufactured, packaged, and distributed in aseptic liquid form in a factory 10. By “aseptic liquid form” is meant that the edible base mix is processed in a manner that includes a procedure that is performed under sterile condition utilizing, e.g., the application of heat or steam, which in turn sterilizes the edible base mix so that it will be stable at room temperature. This step protects the edible base mix during storage and transportation since it will not otherwise be protected from spoilage by temperature control, e.g., refrigeration. The base mix may also be dehydrated or powdered, which would further reduce shipping and storage costs because the water content would be replaced at the site producing the finished product. The edible base mix may be packaged for shipment in bulk. In the context of the present inventions, “bulk” means a quantity (by volume, by weight, or by other such measure) that is significantly greater than that of a typical consumer-sized serving. In the case of food products such as ice cream, for example, a typical consumer-sized serving is commonly measured in single-digit “ounces.” For such a product, “bulk,” in contrast, might comprise a quantity measured in pounds or tens of pounds (in terms of volume, gallons or tens of gallons).

As shown in FIG. 1, the dried probiotic component is mixed with the edible base mix after the mix has been manufactured and aseptically packaged 20. For example, the dried probiotic component may be injected into the aseptically packaged dessert mix. Since this combination step occurs after the edible base mix has been aseptically packaged, the food compositions are essentially free from foreign contaminants.

In an exemplary method, the dried probiotic component may be mixed with the is edible base mix by packaging the base mix in a two component bag, the components separated by a breakable partition. In this embodiment, the first component is the edible base mix and the second component is the dried probiotic component. The partition is physically broken when it is desired to combine the base mix and the dried probiotic. The bag is then shaken to completely mix the components.

In another exemplary method, the dried probiotic component may be mixed with the edible base mix by packaging a dry mixture of the base mix and the freeze dried probiotic, and adding water to activate the probiotic so it acts on the base mix.

The subject food compositions, including the edible base mix component and dried probiotic component, as shown in FIG. 1, may be shipped by a distributor 13, which may be the same as the manufacturer, in un-refrigerated form, to point of sale locations 15, where the final processing or final “manufacturing” of the finished product is to take place. Examples of point of sale locations include ice cream stands, restaurants, supermarkets, or any other site at which apparatus to manufacture portions from the subject food compositions is located. The shipment may be direct from the factory to the distribution site, or may involve intermediate distributors, wholesalers, warehousing, etc.

Illustratively, the distribution may not require deep refrigeration, such as is generally required of ice cream products, which are typically shipped at a temperature of −20° F. in order to prevent spoilage. The equipment to accomplish sub zero transportable refrigeration is extremely expensive, and not only greatly increases the cost of distribution, but also further constrains the distribution process, since it is then not economically feasible to deliver the finished product in small quantities of numerous flavors.

In the present method, however, shipment of small quantities may readily be made without significant economic penalty because the edible base mix component and dried probiotic component are combined after the edible base mix has been aseptically packaged. Thus, the food compositions may be stored and transported at room temperature and are essentially free from foreign contaminants. Even remote non-urban areas which might not otherwise be considered desirable markets because of the cost of distributing product to them may now readily be serviced without greatly increased cost.

The subject food compositions, including the edible base mix component and dried probiotic component, may be shipped by one or more of the common modes of shipping, such as large-volume trucks and other vehicles. It may also be shipped by transportation modes not commonly used for food products such as ice cream, e.g., by parcel post, by express carriers, and the like. Further distribution savings may be achieved in some cases by delivering the base product to food or beverage manufacturers or suppliers who in turn carry the subject food compositions, along with their own products, to the distribution centers. This either may be done on a fee-paying basis, to help the manufacturer or distributor to allay in part the cost of servicing a particular route, or may arise from an ownership interest that the manufacturer or distributor has in some aspect of the distribution process, point of sale locations, etc.

Illustratively, the subject food compositions, including the edible base mix component and dried probiotic component, are prepared for the second and final stage of manufacturing at the point of sale locations 15. At this point, a heating step is performed at a temperature ranging from 86° F. to 120° F. for a period of time ranging from 4 to 24 hours to convert the dried probiotic component to a viable state. After the heating step, the packaged mix is then chilled at a temperature ranging from 40° F. to 55° F., and in certain instances the mix is chilled to 40° F.

The heating step may be performed using any various heater and/or methods available to one of skill in the art. For example, the heating step may use a “clam shell” heater in which the bag is inserted. The two parts of the shell are electrically heated, and the bag warms by radiant energy. The heating step may also be done using a microwave chamber that heats the bag by the emission of microwave radiation. In still another example, the heating step may employ a “swimming pool” chamber where the bag is immersed in a liquid heat transfer medium, such as Dynalene. The Dynalene medium is heated by electric coils and transfers the heat produced by the coils to the bag.

The pH of the subject food compositions is adjusted to a pH ranging from 6.8 to 3.8. The subject food compositions may be converted to a frozen dessert by pumping, spraying, or freezing once the packaged mix has a pH of at least 4.6. Without wishing to be bound by theory, the packaged mix has a pH of 4.6 because it is the isoelectric point of casein molecules wherein casein molecules begin to precipitate or form a gel at a pH of about 4.6. Furthermore, the bacteria may begin log phase growth at about a pH of 6.5, depending on the species.

### Methods of Converting the Subject Compositions to a Frozen Dessert

The illustrative embodiment of the present invention also provides one or more methods of converting the subject food compositions including an edible base mix component and a dried probiotic, probiotics to a dessert food product to provide a beneficial amount of viable probiotic to a consumer. In certain aspects, the dessert food product may be a frozen dessert product. The term “frozen desserts” is a market category that encompasses a wide variety of products that are served at temperatures below the freezing point of water. By “Frozen desserts” is meant a dairy-based food dessert or a non-dairy based dessert. Examples of dairy-based desserts include ice cream, ice milk, sherbet, gelato, frozen yogurt, milk shakes, and soft serve ice cream. Examples of non-dairy-based desserts include mellorine, sorbet, and water ices. Additional frozen desserts for use with the subject compositions and methods, include, frozen novelties such as bars, cones, and sandwiches.

Frozen dessert products, which may be produced in accordance with the methods of the disclosure, may require mixing of selected liquid ingredients with a prescribed volume of air and/or freezing of the resultant mixture, and/or dispensing of the finished frozen product. The desirability of a finished dessert product is often directly related to the manner and the degree to which air is metered and blended with the liquid ingredients of the mixture, referred to herein as overrun, and the manner in which the blended mix is frozen and then dispensed.

For example, in certain instances, the subject food compositions may be converted to a frozen dessert by atomizing the subject food compositions and mixing the subject food compositions with a fluid, such as a gas, and thereafter thoroughly mixing them to form a smooth, relatively homogeneous product, the composition of which is controllable over a wide range of mixtures. In one exemplary embodiment, the subject is food compositions containing an edible base mix component and a dried probiotic component may be atomized before it is mixed with the gaseous fluid. In another exemplary embodiment, the atomization occurs concurrent with the mixing.

In certain instances, mixing may be achieved by passing the subject food compositions under pressure, through an extended conduit under conditions such that turbulent mixing occurs. In particular, in the formation of an aerated product such as ice cream or frozen yogurt, the atomization process breaks up the subject food compositions into fine particles, while the confinement of the particles and air stream in the conduit creates turbulent mixing of those ingredients thereby causing the air to become very thoroughly mixed with the liquid mix particles.

The amount of aeration in the product is a function of a number of factors, such as for example, the length of the conduit, the inside diameter of the conduit, the discharge velocity from the mixing space into the conduit, the particle size of the subject food compositions, the ratio of the gas to food compositions, the volume flow rate, the density and viscosity of the composition, the subject food composition surface tension, and the temperature of the mixture. During transit through the turbulent mixing passage, the flavoring and/or other additives may be thoroughly mixed with each other and/or with the air to form a smooth relatively homogeneous product of fine particles. Although the extent of mixing may be controlled by varying one or more of these factors, the conduit length provides a convenient basis for control of the amount of aeration.

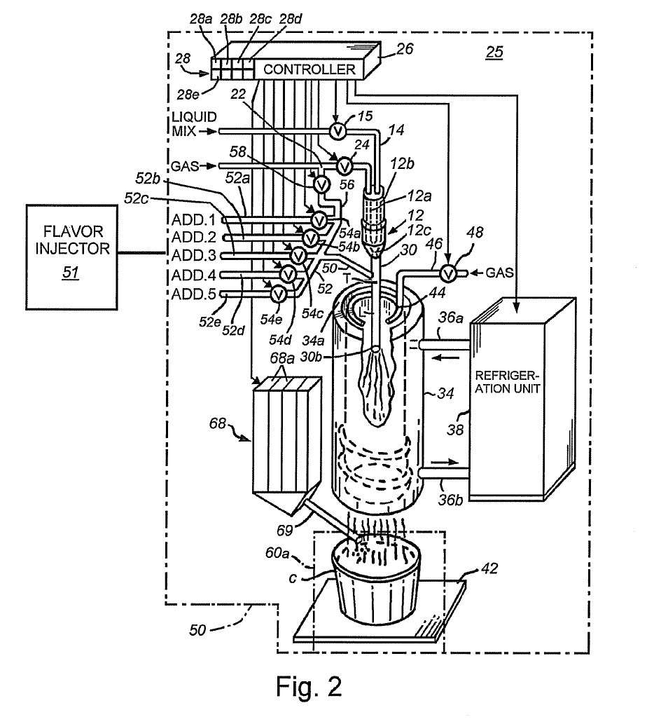

A typical device for converting the subject food compositions into a frozen dessert is depicted in FIG. 2. In this example, the device for producing a frozen product such as ice cream is indicated generally as machine 25. The subject food compositions as described above have been mixed together and are essentially free from foreign contaminants. The mixed composition is added to the mixing chamber 12 defined, in this embodiment, by a vertically oriented air atomizing nozzle 12 having a first inlet 12a for liquid, a second inlet 12b for air or other gas, and a single discharge outlet 12c. Connected to the inlet 12a is a conduit or tube 14 which leads from a source (not shown) of the subject food composition to air atomizing nozzle 12. In certain aspects, the edible base mix component and dry probiotic component are provided separately and mixed is together in the mixing chamber 12. Once the edible base mix component and dried probiotic component have been added to the mixing chamber, a hydrolyzing step (151) shown in FIG. 1 must be conducted to convert the dried probiotic from a quiescent state to a viable state while at the same time controlling the pH of the mixture. Specifically, a heating step (151a) is performed at a temperature ranging from 90° F. to 110° F. for a period of time ranging from 4 to 8 hours to convert the dried pro biotic component from a quiescent state to a viable state, and to allow time for the growth, and subsequent generation of lactic acid which lowers the pH of the mix. The heating step is completed when a time/temperature indicator strip affixed to a base mix bag turns a specific color. After the heating step, the packaged mix is then chilled at step 151b to a temperature ranging from 40° F. to 50° F., and in certain instances the mix is chilled to about 40° F. for two to four hours.

The pH of the subject food compositions may then be adjusted to a pH ranging from 3.5 to 6.8 in step 151c to ensure the proper acidity for the food composition. For example, the pH of the food composition may be adjusted by the addition of either a basic agent, if the pH needs to be increased, or an acidic agent if the pH needs to be decreased. Exemplary acidic agents include but are not limited to lactic acid, glucono delta lactone, citric acid, adipic acid, fumaric acid, succinic acid, malic acid, oxalic acid, or tartaric acid. Exemplary basic agents include but are not limited to, sodium or calcium carbonate, magnesium oxide, sodium hydroxide, magnesium carbonate, or magnesium hydroxide. In certain instances, the pH may be adjusted by a suitable ion exchange resin. The subject food compositions are ready to be converted to a frozen dessert by pumping, spraying, or freezing once the mix has a pH ranging from 3.5 to 6.0.

Without wishing to be bound by theory, the pH is significant because it affects the flavor of the mix. If the mix is too acidic (pH below 5.0), flavors such as vanilla or chocolate will taste too sour. A pH of 4.6, however, is the point at which casein is most unstable in a solution, and precipitates, forming a gel thus it is optimal for the manufacture of gelato and other frozen desserts. The pH reduction can be caused by lactic microorganisms or direct acidification. Glucono delta lactone, which slowly hydrolyzes into gluconic acid, has been used in the dairy industry to lower pH gradually is in such applications as cottage cheese and yogurt manufacture. As such, the milk proceeds to gel or precipitate, but does not include any of the associated flavor of the cultures. Furthermore, the generation of acid in microorganisms is directly proportional to their number and viability. In other words, the lower the pH, the more probiotic organisms are present. However, this is only to a point. When the bacteria reach a pH of 3.5, their growth is slowed dramatically and they stop proliferating.

As noted above, the subject food compositions is illustratively for making a frozen food product, such as ice cream which may further include an aerating step 153. The gas for aerating the liquid mix, which includes the subject food compositions, is supplied to nozzle 12 by a pipe 22 leading from a gas source (not shown) which delivers the gas at a pressure above atmospheric. Pressures from 5 psi to over 100 psi may be used in the illustrative embodiment of the present invention to deliver the gas into nozzle 12. The gas may be air or any other non-toxic gas customarily used to provide overrun in conventional ice cream products. The flow of gas to nozzle 12 is controlled by a solenoid-actuated valve 24 in line with pipe 22 much like value 16 which controls the flow of the liquid mix into nozzle 22. The operations of valves 16 and 24 are controlled by output signals from a controller 26 which has an accessible key pad 28 by which an operator can control the operation of apparatus 25.

The atomized mix, which includes the subject food compositions, issuing from the mixing chamber 12, i.e. from nozzle outlet 12c, is directed into one end of a relatively long, e.g. 2 to 24 inches, relatively small diameter, e.g. 0.08 to 0.24 inches, turbulent mixing passage in the form of a conduit 30 wherein the effluent from nozzle 12 is subjected to considerable turbulence and buffeting because being passed through the conduit 30. Thus, there is violent turbulent mixing of the atomized mist particles and the gas, in the conduit, as shown as T in FIG. 2 which causes the particles of the subject food compositions to coalesce and form somewhat larger particles. At the same time, gas is entrapped within the particles and consequently, the fluid issuing from the discharge end 30b of conduit 30 is comprised of approximately uniformly sized, relatively small aerated particles with the air enclosed within an outer generally continuous “skin” formed by the mixing.

During passage through a cooling chamber 34, the particles are “flash” frozen in a few, e.g., 1 to 10, seconds due to the relatively high ratio of surface area to volume of the particles emerging from the conduit. The small particles emerging from the conduit, combined with the flash freezing of each particle, produce a uniform and smooth frozen dessert in accordance with the present disclosure. Further, it is calculated that the energy requirements of the process lie within the range of conventional freezing machines.

Referring again to FIG. 2, positioned below the turbulence conduit 30 is a vertically oriented tubular cooling chamber/chiller 34 which has a central passage 34a for receiving a discharge end 30b of conduit 30, the chamber 34 extending an appreciable distance below the conduit. Formed in the wall of chamber 34 is a helical passage 36 for circulating refrigerant through the chamber. The upper and lower ends of the passage 36 are connected by pipes 36a and 36b to the outlet and inlet, respectively, of a refrigeration unit 38. Unit 38 may also be controlled by controller 26.

Spaced below the lower end of chamber 34 is a horizontal shelf or tray 42 for supporting a container such as a paper or plastic cup C. Cup C is normally positioned directly below the central passage 34a in chamber 34 so that it is in position to catch or receive ice cream dropping under the influence of gravity from the lower end of the chamber passage 34a.

The diameter of chamber passage 34a is sufficiently large so that the aerated mix particles issuing from the conduit end 30a may not contact and coat the wall of that passage. This minimizes the need to clean the surface/wall of the passage. The buildup of particles on that interior wall can be further avoided by providing an air barrier or boundary layer adjacent to the passage wall. To provide such an air boundary layer, apparatus 25 may include, at the top of chamber passage 34a, a circular pipe 44 having a multiplicity of small holes (not shown) in its underside. Pipe 44 is connected to a gas source (not shown) by way of a pipe 46 having an in-line solenoid-actuated valve 48 controlled by controller 26. When valve 48 is opened, e.g. just before each dispensing cycle, a downwardly directed cylindrical layer of air helps isolate the wall of passage 34a from the fluid issuing from conduit 30. As the aerated mix particles pass though the chiller 34, they are cool to a semi solid or solid form to produce for example an ice cream is product in step 155 of FIG. 1.

The components of apparatus 25 may be housed in a housing shown in phantom 60 in FIG. 2, an appropriate opening 60a being provided in a wall of housing 60 to provide access to the shelf 42 so that a cup C can be positioned on the shelf as shown in FIG. 2 to collect the dispensed converted frozen dessert that provides a beneficial amount of viable probiotics to a consumer.

Key pad 28 has selection keys or buttons 28a to 28e corresponding to the valves 54a-e to enable the operator to select a flavor of ice cream product to be dispensed by apparatus 25 in step 152 of FIG. 1. Controller 26 is programmed so that when the operator presses a key, for instance key 28a, the controller 26 applies timed actuating signals to valves 16 and 24, thereby opening those valves so that non-flavored liquid ice cream mix and gas are fed to nozzle 12 in the proper ratio. As nozzle 12 sprays these fluids into conduit 30, controller 26 sends a signal to the flavor injector 51 in step 154 of FIG. 1 to valve 54a opening that valve so that additive 1, e.g. vanilla extract, is injected by way of manifold 52 into conduit 50 which intersects with conduit 30 below nozzle 12c, so that the additive is entrained in the effluent from nozzle 12 and thoroughly mixed into the liquid mix being aerated in the conduit 30. The signals from controller 26 that control valves 16, 24 and 54a cause those valves to remain open for the time required for the apparatus 25 to dispense a selected volume of ice cream product, e.g. one portion or serving of vanilla ice cream, that will fill the cup C on shelf 42. Then valves 16, 24, and 54a close so that substantially no additional fluid flows from the conduit 30.

The illustrated apparatus also allows for addition of liquid or solid materials to the frozen product in container C. In particular, a plural compartment dispenser 68 is provided adjacent to chamber 34. The dispenser/mix-ins chamber has several compartments 68a which may contain various materials such as chopped nuts, jimmies (sprinkles), chocolate syrup, etc. In response to actuation of the appropriate key of key pad 28, controller 26 causes the dispenser to dispense the selected material through a common outlet tube 69 whose discharge end overlies container C. The material will be incorporated into, or added to the top of, the product in container C in step 156 of FIG. 1, depending upon when the dispensing is commenced in step 157 of FIG. 1 through the is opening of cooling the chamber 34.

As soon as the cup C has been filled, it can be removed and replaced by an empty cup. The operator can then fulfill the request of the next customer. If that next customer wishes a different flavor ice cream, e.g. raspberry, the operator can press the key pad key corresponding to that flavor, e.g. key 28c. In response, controller 26, in addition to opening valves 16 and 24 as before, will now open valve 54c so that raspberry flavoring will be fed to conduit 30 and entrained in the non-flavored ice cream mix issuing from nozzle 12. In accordance with the present invention, each customer will receive ice cream in cup C which includes a viable probiotic component.

Advantageously, the present invention provides for a system and method for producing an food composition containing probiotics which can be shipped at room temperature to a final point of sale where the mixed food composition is then converted into a frozen food product with minimal adverse effects to the probiotics viability.

The above method and apparatus is exemplary and not to be construed as a limitation. Additional exemplary methods and apparatuses, known to one of skill in the art, may be employed for converting the subject compositions comprising an edible base mix component and a freeze dried component comprising probiotics to a frozen dessert. For example, additional methods and apparatuses for use in the present invention are described in U.S. Pat. Nos. 5,292,030; 5,433,967; 5,473,909; 5,603,257; 5,727,713; 5,758,571; 5,868,065; 6,698,228; 6,745,595; 6,907,741; 6,941,858; 6,952,928; 7,052,728; 7,131,279; and in US Patent Publication Nos: 2006/0054614; 2006/0162348; 2006/0162347; 2006/0003065; 2007/0251260; and in PCT Application Nos.: WO 92/102146; WO 03/041513; WO 2004/019707; and WO 2006/076733; the disclosures of which are herein incorporated by reference.

All publications and patents cited in this specification are herein incorporated by reference as if each individual publication or patent were specifically and individually indicated to be incorporated by reference.

It is also to be understood that this invention is not limited to particular embodiments described herein, as such, the present invention may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

It is further noted that the claims may be drafted to exclude any optional element. As such, this statement is intended to serve as antecedent basis for use of such exclusive terminology as “solely,” “only” and the like, in connection with the recitation of claim elements, or the use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step, or steps, to the objective, spirit, and scope of the invention. All such modifications are intended to be within the scope of the claims appended hereto.

What is claimed is:

1. A food composition comprising:
an edible base mix component, aseptically processed at a factory prior to shipment of the food composition to a final point of sale, the aseptically processed edible base mix; and
a dried probiotic component added to the edible base mix component after the edible base has been aseptically processed to allow the food composition containing the dried probiotic component to be shipped at room temperature without any refrigeration of the food composition during shipment.

2. The composition of claim 1, wherein the probiotic component comprises at least one strain of the genera Lactobacillus, Bifidobacterium, or Streptococcus.

3. The composition of claim 1, wherein the food composition is processed at the final point of sale to produce a frozen dessert.
